(19) United States
(12) Patent Application Publication
(10) Pub. No.: US 2014/0196298 A1
(43) Pub. Date: Jul. 17, 2014

(54) POSITIONING DEVICE FOR ASPHALT SHINGLES

(71) Applicant: Gary George, Hot Springs, AR (US)

(72) Inventor: Gary George, Hot Springs, AR (US)

(21) Appl. No.: 13/739,082

(22) Filed: Jan. 11, 2013

(51) Int. Cl. G01B 5/16

(52) U.S. Cl. CPC G01B 5/16
USPC 33/648

(57) ABSTRACT

A tool, or template, for the accurate positioning of asphalt shingles on a roof having a valley, wherein first and second plates, each with leading edges, are coplanar and exactly 5 inches apart, held there by struts. The first plate being longer than the second plate by a predetermined distance to the left and right thereof and the ends of the leading edge being tapered at a 45° angle. Handles are attached to the first and second plates extending from one to the other, and those handles are insulated to inhibit injury to the roofer using the tool.

The present invention relates, generally, to the task of roofing with asphalt shingles and, more particularly, to a positioning device for accurately and quickly setting each shingle relative to its adjacent shingle.

### BACKGROUND OF THE INVENTION

1. Field of the Invention

Asphalt shingles are a popular roofing material in a great number of venues in the United States and elsewhere. Such shingles are affixed to one another in overlapping relation on a pitched roof. They are typically nailed into place once properly positioned.

By virtue of the fact that the shingles are in a predetermined and uniform pattern and highly visible from ground level in most cases, any deviation in the pattern is immediately recognizable to individuals at ground level, and it suggests, at least tacitly, poor quality.

It is common practice among roofing contractors to enter into a fixed fee contract with the owner or building contractor. Thus, time is of the essence in such contracts, while appearance, safety, and weatherproofing are at the forefront. Workers are urged to move quickly as they set and fix the shingles, but, as can readily be imagined, working on a pitched roof is no small task. The task is magnified where, as is the case in most roofs, there is a valley to be shingled.

Each workman must set and affix each shingle at the absolute proper place while supporting himself, typically by the tread on his/her shoes against the paper subbase to which each shingle is nailed, or otherwise secured. Accordingly, each workman is charged with the unenviable task of avoiding a potentially disastrous fall, well setting shingles in a uniform pattern, in a minimum amount of time.

2. Overview of the Prior Art

While the present invention might not be considered a pioneer in its field, the art, as of the present time, suggests that it is rather clearly the best and most workable.

Mills for example, in his U.S. Pat. No. 2,887,781, suggests the ruler type device comprising two plates, slidable relative to one another, to position a shingle. The plate 16 is movable relative to the plate 16, and a wingnut helps to affix the one to the other so that consecutive rows of shingles can be accommodated.

In a similar fashion, Sucheck U.S. Pat. No. 4,110, 911 employs a pair of bars 12 and 14 separated by arms 22 and held in position by knurled nuts 40. Stewart U.S. Pat. No. 4,541,217 offers yet another pair of bars, which are hinged to one another, and finally, Siegfried U.S. Pat. No. 6,189,227 offers a very complex system, which includes a system similar to Sucheck.

Each of the foregoing patents is deficient in one respect or another, and none of them address the more complex problem of positioning shingles in the valley of a roof.

### SUMMARY OF THE INVENTION

The present invention is a simple, yet profoundly accurate, unitary positioning device for use by a single roofer as he/she sets and secures asphalt shingles.

Accordingly, it is a principal objective of the present invention to provide to the artisan a tool in the nature of a template, or jig, capable of assisting the artisan as he positions and secures shingles, not only along the flat portion of the roof, but in the valleys thereof.

It is a further objective, related to the foregoing, to accomplish the principal objective of the present invention with great simplicity and reliable accuracy.

Further, the tool is of such simple construction that a skilled artisan, as well as an unskilled journeyman, can readily understand it and use it to accomplish the objectives of the present invention.

In recognition of the nature of the roofing business where speed and accuracy are vital, the simplicity, of the present tool is such that a workman, irrespective of the level of skill, can position and set asphalt shingles with both speed and facility.

By virtue of the simplicity, of the tool which is capable of meeting all of the objectives established for it, the task of roofing a structure with asphalt shingles, is both visually attractive and economical to accomplish. Moreover, the tool is sufficiently stout that it can be tossed around and even fall from the roof without any damage to its ability to accomplish those objectives established for it.

The foregoing, as well as other objects and advantages of the present invention, will be apparent to those skilled in the art, with the reading of the following Detailed Description Of The Preferred Embodiment, read in conjunction with a Description Of The Drawings.

### BRIEF DESCRIPTION OF THE DRAWINGS

FIG. 1 is a pictorial representation of the tool of the present invention shown in perspective;

FIG. 2 is an end view of the tool of FIG. 1;

FIG. 3 is a top plan view of the tool of FIG. 1, and establishing a 45° angle suitable to permit the artisan to position and secure shingles in the valley of the roof;

FIG. 4 is a side elevational view of the tool of FIG. 1;

FIG. 5 is a pictorial representation of the tool of the present invention as it would appear in use in establishing shingles at the valley of the roof; and,

FIG. 6 is a view looking down from above the roof and showing the tool of the present invention in position as it would appear to the roofer as he/she works.

### DETAILED DESCRIPTION OF A PREFERRED EMBODIMENT

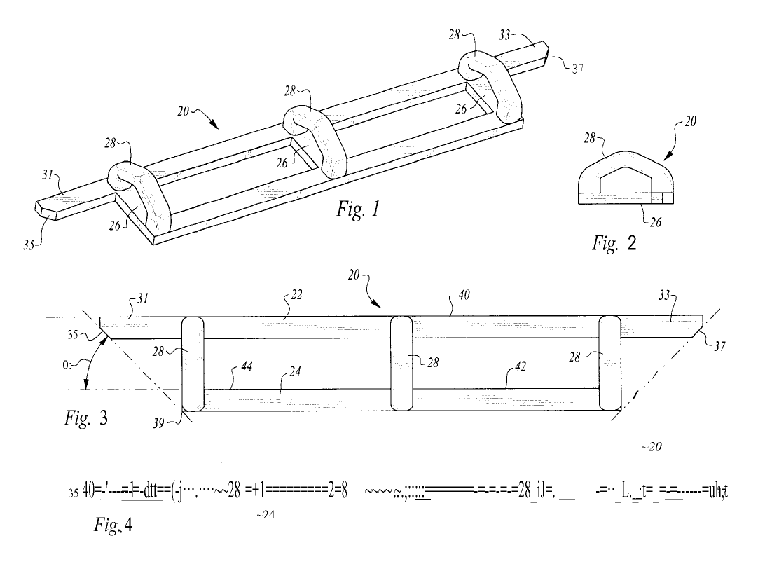

With reference now to the drawings, and initially to FIGS. 1 through 4, a tool constructed in accordance with the present invention is illustrated at 20. The tool 20 is specifically designed and configured to serve as a template for the artisan [roofer] and others who would undertake the task of applying asphalt shingles, including, but not limited to, architectural and three tab shingles.

The tool 20 is distinguished by its simplicity in construction, while offering unprecedented utility, and accuracy. As perhaps best seen in FIG. 3, a pair of plates 22 and 24 are provided. The plate 22 is longer than the plate 24 for reasons which will soon become evident. The ends of the plate 22 extend to the left and right of the tool by an equivalent amount. The plates are coplanar and parallel to one another and are held together by struts 26, which are of rigid material and of identical length, thereby holding the plates 22 and 24 apart by the identical distance. In a typical situation, the plates are affixed at 5 inches apart. The tool 20 is assembled in such a manner that all connecting elements are rigid with respect to one another thereby rendering the entire tool rigid.

In a preferred application, the tool is constructed of three-quarter inch plate and between 30 and 41.25 inches in length.

In order that the tool 20 can be handled by a single user, handles are provided. Accordingly, handles 28 are positioned immediately above the struts 26. There are three in number so as to permit the user to grasp the tool while he/she is in a variety of positions which the user might assume in order to protect against possible dis-lodgment and consequent injury while working on the side of a pitched roof.

It is well understood that roofing is often done in the late spring through the early fall, all of which times expose the roofer to substantial exposure to the sun. As an additional feature of the present invention, therefore, the handles 28 are wrapped, or coded, with an insulation material which resists the absorption of heat. Therefore, the handles may be gripped with ease and relative comfort despite the tool having been left in the hot sun for a length of time.

It is common in architectural circles to design, particularly, residential structures, with a gabled roof. Those gables create, what is known in the roofing industry, as a valley. More specifically, whereas the sides of the pitched roof are essentially planar, or flat, the roof of the valley will extend upwardly from the flat portion of the side of a roof at a 45° angle. A compelling feature of the present invention is the ability of the roofer to transition, almost seamlessly, from the setting of shingles on the flat portion of the roof to the valley.

In order to assist in achieving this benefit, it will be observed that the remote extensions, or ends, 31 on the left and remote extensions, or ends, 33 on the right, are beveled at 35 on the left and 37 on the right, both at a predetermined angle, preferably a precise 45° angle. Thus, a 45° angle a is created between the beveled surface 35 and the lower edge 39 of the bar 24.

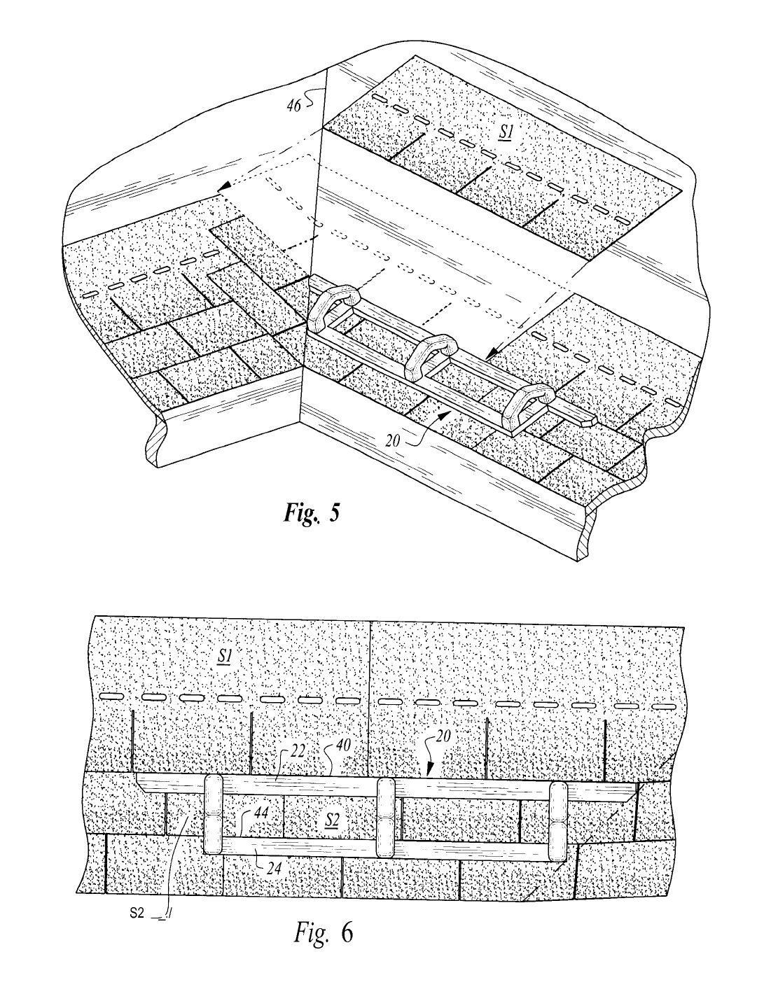

Moving now to know FIGS. 5 and 6, the tool 20 may be seen in use in FIG. 5, for example, the tool 20 rests just above the base of the flat portion of the pitched roof R. A typical asphalt shingle 51 is moved to the leading edge 40 of the longer plate 22 on the path of arrows 42. The tool 20 has been positioned with the leading edge 44 of the shorter plate 24 abutting the previously laid shingle 52. With the shingle 51 having thus been positioned, it will be seen that it is precisely aligned and ready to be nailed in place.

Referring specifically to FIG. 5, it will also be observed that the left end bevel 35 is on the meridian line 46 separating the flat portion of the roof from the valley thereof, from which position the roofer can commence to apply shingles to the portion of the roof which is at 45°.

While the preceding description is intended to chronicle the various features of a preferred embodiment of the present invention, those skilled in the at will be able to perceive minor alternatives to specific features. It will be understood, however, that the present invention anticipates and encompasses such variations as may be seen from the following claims, wherein:

1. A positioning tool for the accurate placement of asphalt shingles on a roof having at least one valley comprising, in combination:
a first plate, said first plate having a leading edge, said leading edge being straight;
a second plate, said second plate having a leading edge, said leading edge of said second plate being straight;
said first plate and said second plate being in a single plane;
said first plate having a left extension and a right extension; each extension and said left extension forming a predetermined angle with the leading edge of said second plate;
said first plate and said second plate being positioned at a predetermined distance relative to one another, at least one handle supported by said first plate and said second plate to permit handling of said positioning tool.

2. The positioning tool of claim 1, wherein said left extension and said right extension each having a taper formed at the remote end thereon, the taper of each said left and said right extension forming a 45° angle with the longitudinal axis of said first plate.

3. The positioning tool of claim 1, wherein said plates are rigidly held in position by struts.

4. The positioning tool of claim 1, wherein three handles are provided.

5. The positioning tool of claim 3, wherein a handle is provided immediately above each said strut.

6. A unitary positioning tool for the accurate placement of asphalt shingles on a roof having at least one valley comprising, in combination:
a first plate, said first plate having a leading edge, said leading edge being straight;
a second plate, said second plate having a leading edge, said leading edge of said second plate being straight;
said first plate and said second plate being in a single plane;
said first plate having a left extension and a right extension; each extension and said left extension forming a predetermined angle with the leading edge of said second plate;
said first plate and said second plate being positioned at a predetermined distance relative to one another, at least one handle supported by said first plate and said second plate to permit handling of said positioning tool.

7. The unitary positioning tool of claim 6, wherein each said plate is of a thickness greater than the thickness of a shingle.

8. The unitary positioning tool of claim 6, wherein said left extension and said right extension each having a taper formed at the remote end thereon, the taper of each said left and said right extension forming a 45° angle with the longitudinal axis of said first plate.

9. The unitary positioning tool of claim 6, wherein said plates are rigidly held in position by struts.
